(19) United States
(12) Patent Application Publication
(10) Pub. No.: US 2014/0136297 A1
(43) Pub. Date: May 15, 2014

(54) INCREMENTALLY DEVELOPING BUSINESS PERFORMANCE INDICATORS

(71) Applicant: CA, INC., Islandia, NY (US)

(72) Inventor: Michel S. Milano, Oakland, CA (US)

(73) Assignee: CA, INC., Islandia, NY (US)

(21) Appl. No.: 13/674,231

(22) Filed: Nov. 12, 2012

(51) Int. Cl. G06Q 10/06

(52) U.S. Cl. 705/7.39

(57) ABSTRACT

A method, system and computer program product for developing a business performance indicator for an organization comprises receiving from a first member of the organization a first metric formula M₁ related to a first operational value of the organization; receiving from other members of the organization feedback information related to the first metric formula M₁; receiving from the first member of the organization a refined metric formula based on the first metric formula M₁ and the feedback information; and outputting the business performance indicator calculated according to the refined metric formula.

### BACKGROUND

The present disclosure relates to business performance indicators, and more specifically, to developing business performance indicator metrics.

Performance measurement and setting business goals are typically seen as being beneficial to growing a business. Knowing how the different aspects of the business are performing may provide helpful information about why a business is growing or about what may be causing a change in performance. One challenge with measuring, or managing, performance is selecting what to measure. Ideally, businesses would like to identify quantifiable factors that are clearly linked to the success or growth of the business, i.e., reaching their business goals.

These quantifiable factors may be financial measures of performance but not necessarily so. In an Information Technology (I.T.) centric business, for example, there may be various data available regarding operational parameters of hardware resources and there may also be information available about costs involved with operating these hardware resources. However, simply having techniques to measure available information does not necessarily allow meaningful business performance indicators to be identified and developed. The leap from what can be easily measured at an operational level of the business to setting meaningful and useful strategic business goals for an organization is a difficult task.

### BRIEF SUMMARY

One aspect of the present disclosure relates to a method for developing a business performance indicator for an organization that comprises receiving, by a computer, from a first member of the organization a first metric formula M₁ related to a first operational value of the organization; receiving, by the computer, from other members of the organization feedback information related to the first metric formula M₁; and receiving, by the computer, from the first member of the organization a refined metric formula based on the first metric formula M₁ and the feedback information. The method further comprises outputting, by the computer, the business performance indicator calculated by the computer according to the refined metric formula.

Another aspect of the disclosure relates to a system for developing a business performance indicator for an organization that comprises a computer processor configured to execute instructions stored in a memory. The system includes a first interface module configured to receive from a first member of the organization a first metric formula M₁ related to a first operational value of the organization; a second interface module configured to receive from other members of the organization feedback information related to the first metric formula M₁; the first interface module configured to receive from the first member of the organization a refined metric formula based on the first metric formula M₁ and the feedback information; a calculator module configured to calculate the business performance indicator according to the refined metric formula; and a communication module configured to output the calculated business performance indicator.

Yet another aspect of the disclosure relates to a computer program product for developing a business performance indicator for an organization that comprises a computer readable storage medium having computer readable program code embodied therewith. In particular, the computer readable program code comprises computer readable program code configured to receive from a first member of the organization a first metric formula M₁ related to a first operational value of the organization; computer readable program code configured to receive from other members of the organization feedback information related to the first metric formula M₁; computer readable program code configured to receive from the first member of the organization a refined metric formula based on the first metric formula M₁ and the feedback information; and computer readable program code configured to calculate the business performance indicator according to the refined metric formula and output the calculated business performance indicator.

### BRIEF DESCRIPTION OF THE DRAWINGS

Aspects of the present disclosure are illustrated by way of example and are not limited by the accompanying figures with like references indicating like elements.

FIGS. 1 and 2 illustrate a flowchart of an exemplary process for incrementally developing business performance indicators in accordance with the principles of the present disclosure.

FIG. 3 illustrates a system that may implement the process of FIGS. 1 and 2 in accordance with the principles of the present disclosure.

FIG. 4 is a block diagram of a data processing system in accordance with the principles of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CORaM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In general, business performance metrics may, for example, be classified into three different levels. However, these classifications are provided by way of example to assist in describing concrete example principles of the present disclosure. One of ordinary skill will recognize that other classification schemes are possible without departing from the scope of the present disclosure. “Low”-level metrics can be operational characteristics or values related to a physical environment of an organization and are typically easily and directly measured. Thus, an operational value can comprise a measured hardware or software performance metric. For example, in a server farm of dozens of servers, each server may have an individual response time to a request from a respective client, each server may have a CPU load measure, each server may have a measure of what percentage of memory is being used, each server may have a measure of how many applications are active each second, each server may have a measure of how many users are active each second, and each application on a server may have an individual response time to client requests. These measured performance metrics, whether for hardware or software resources, are typically easily identified and measured operational values that can be captured by an organization.

A next level of metrics can be labeled as tactical performance metrics and may be built by combining operational metrics in various ways. For example, mean-time-to-repair (MTTR) is one possible measure of reliability of an organization's hardware resources and availability or uptime may be alternative measures related to reliability. Additionally, tactical performance metrics can include such values as averages of the individual server measures identified above (e.g., average response time for all servers). One of ordinary skill will recognize that composite, or compound, tactical metrics can be formed by combining different operational measurements in a variety of ways without departing from the scope of the present disclosure.

“High”-level metrics may be labeled strategic metrics and are complex business performance indicators whose value may depend on a variety of different operational measurements and tactical metrics. For example, an organization may have a strategic metric, i.e., business performance indicator, related to customer satisfaction and, more particularly, have a goal of 95% customer satisfaction for web-based transactions. While this strategic metric may be simple to calculate after-the-fact, identifying and measuring the available operational and tactical information that will be critical in achieving the strategic goal is difficult.

Thus, the organization may identify a business performance indicator that reflects if customers will be satisfied with their web-based transactions when using the organization's on-line shopping site. However, the organization may not initially know what operational and tactical information may be helpful in defining and calculating that business performance indicator. In accordance with the principles of the present disclosure, individuals within the organization may collaborate to determine initial operational and tactical metrics of interest and then incrementally refine them in order to derive a measurement for the desired business performance indicator.

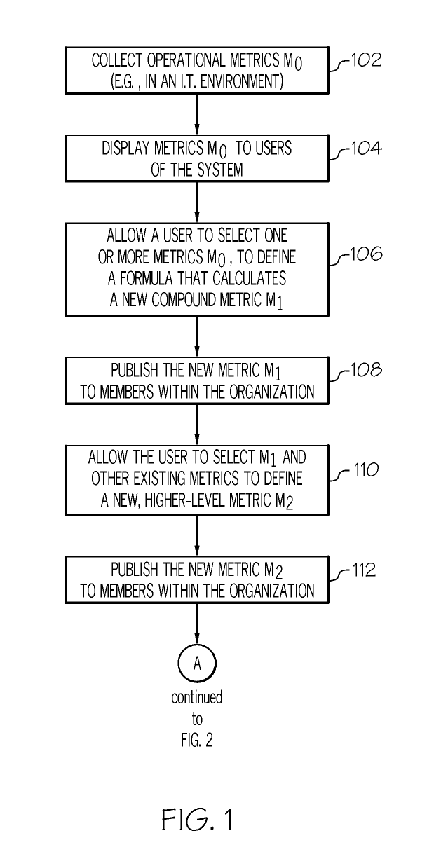

FIG. 1 depicts a flowchart of an exemplary process for developing a business performance metric or indicator in accordance with the principles of the present disclosure. In step 102, a variety of operational metrics M₀ can be collected or measured. As mentioned above, in an I.T. environment, such metrics can include individual performance measurements of hardware resources such as servers and the like. These metrics can be displayed, in step 104, to users of a system in order to help define and refine development of a new business performance indicator. In particular, there may be two classes of users of such a system. One class of user can be referred to as an “owner” of the new business performance indicator. The owner may be an individual or team of individuals within an organization that have a responsibility for directing the development of the new business performance indicator. Another class of users can be referred to as “external users”. The external users may be members of the organization that have some insight into the new business performance indicator or may utilize the new business performance indicator in their role within the organization. While the owner may have responsibility for the new performance indicator, the external users can contribute and collaborate with the development of the new business performance indicator.

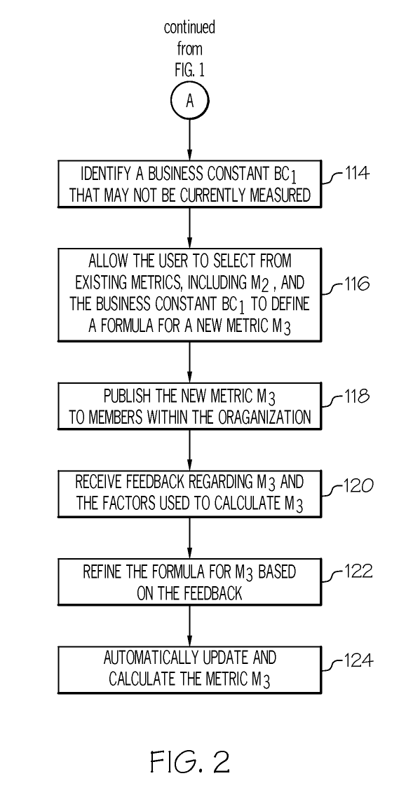

In the description below, a particular example metric formula is provided and then refined. This metric formula is provided as an example only and is merely intended to provide a concrete example of how the collaborative and iterative process of FIGS. 1 and 2 may be utilized. In operation, the process of FIGS. 1 and 2 may be used by an organization to identify operational parameters that are measured and performance indicators that may rely on these parameters. The business analysts and other specialist within the organization may then rely on their expertise and knowledge to define, refine, and derive a wide variety of metric formulas and business performance indicators according to the principles of the present disclosure.

In step 106, the owner of the new business performance metric can select from the various available operational metrics M₀ to define a new compound metric M₁. The new compound metric may be a combination of one or more of the operational metrics M₀ that are measured and available. For example, the owner may determine that average server response time of a plurality of servers is a useful metric in determining whether customers at the organization's web site are satisfied. If there are n servers and each has a respective response time tₙ, then the owner may define a metric M₁ that is the average of all the different response times for all the different servers.

Once this new metric M₁ is defined, it can be published, in step 108, within the organization. The extent of the publishing of the metric M₁ can be controlled based on a variety of factors. For example, the new business indicator development process can be a computer implemented process utilizing one or more computers. One or more first members within the organization, such as the one or more users defining the owner of the business performance indicator, may have access to those one or more computers and, hence, can have access to the published metric M₁. Other members, such as external users, may also have access to those computers and, hence, can also have access to the published metric M₁. Such access, for example, can be accomplished using messaging technology wherein a new metric is pushed to each user via an e-mail message or similar message. Alternatively, new metrics can be collected in storage such that a member can actively search for new published metrics and determine which ones may be of interest.

Access to the metric M₁ can also be controlled by what role an external user has within the organization. For example, users within a financial department of the organization may have access to different metrics M₁ than users in a research and development department of the organization. Similarly, users having different managerial roles within the organization may have access to different metrics M₁ based on those roles.

In response to the publishing of the metric M₁ or simply the passage of time in which the metric M₁ is observed within the organization, the owner of the business performance indicator may receive feedback from external users or independently identify refinements that can be made to the metric M₁. Thus, in step 110, the owner can define a new, higher-level metric M₂ that utilizes metric M₁ but in a refined manner. For example, the metric M₁ may, as mentioned above, reflect an average server response time: M₁=RT_{avg}. However, the owner may determine that this metric M₁ in addition to an average CPU load, L_{avg}, of the servers provides more useful information. Therefore, the owner can define a formula for the higher-level metric M₂ such that M₂=M₁*L_{avg}.

In step 112, the owner publishes the new metric M₂ to members of the organization. The members who have access to the new metric M₂ can be the same members who had access to the earlier metric M₁. However, because M₂ can include additional information, the members to whom metric M₂ is published can be different than those members to whom metric M₁ was published.

Continuing with FIG. 2, the owner of the business performance indicator identifies, in step 114, a business constant BC₁ that may be useful in conjunction with the metric M₂. Business constants are defined or derived values within an organization that are relatively static or do not rely on “live data” such as metrics M₀. A business constant, for example, may be a target value defined by an organization that does not change. Such target values can be quarterly revenue, target uptime, or target number of orders. Business constants can also be measured values that are only available after-the-fact such as cost-per-user, cost-per-server, or cost-per-transaction for the last quarter (or the last month, or the last year, etc.). The owner may identify multiple business constants that are helpful in developing a new business performance indicator.

In step 116, the owner of the business performance indicator can select from the metrics M₀, M₁, M₂ and the business constants BC₁ to develop a formula for a new metric M₃ that is a refinement of the metric M₂. For example, the business constant BC₁ can relate to a cost per server, CPS, that the organization calculated for the last quarter. The organization may be interested in capturing in a business performance indicator the effect of whether that cost is increasing or decreasing. Thus, the metric M₂ can be refined such that a new metric M₃ is defined, where M₃=M₂/CPS. Accordingly, as the cost-per-server, CPS, increases, the metric M₃ decreases and vice-versa.

The new metric M₃ may be useful but may still be improved upon. Thus, in step 118, the metric M₃ and its formula can be published to members of the organization. The owner of the business performance indicator receives feedback, in step 120, regarding the metric M₃. The feedback can include comments by different members within the organization but may also include new business information. For example, the organization may have new revenue goals or new performance goals. Additionally, new metrics M₀, M₁, and M₂ may become available that can be incorporated into the formula for the metric M₃.

Based on the feedback or new information, the owner may modify, in step 122, the formula for the metric M₃. One particularly useful refinement of the metric M₃ can include replacing the business constant BC₁ with “live” data. Rather than relying on a value that is relatively static, the organization can identify low-level metrics or measured data that is highly correlated with the business constant BC₁. For example, if the CPS business constant, after an initial capital outlay, is mainly dependent on the daily cost of utilities for powering the server farm, then the “live” data of the daily electrical power consumption, EPC, of the server farm is highly correlated to the business constant BC₁. Thus, in step 122, the owner of the business performance indicator can refine the formula for the metric M₃ to replace the business constant BC₁ with the “live” data such that M₃=M₂/(EPC). The term “live” data refers to dynamic values that can be currently measured rather than a previously derived “constant” value.

The refined metric M₃ can be considered as a new business performance indicator that is indicative of a business goal (e.g., desired customer satisfaction) that was derived in a collaborative and incremental manner in accordance with the principles of the present disclosure. The metric M₃ can be calculated and updated, in step 124, when desired by the organization.

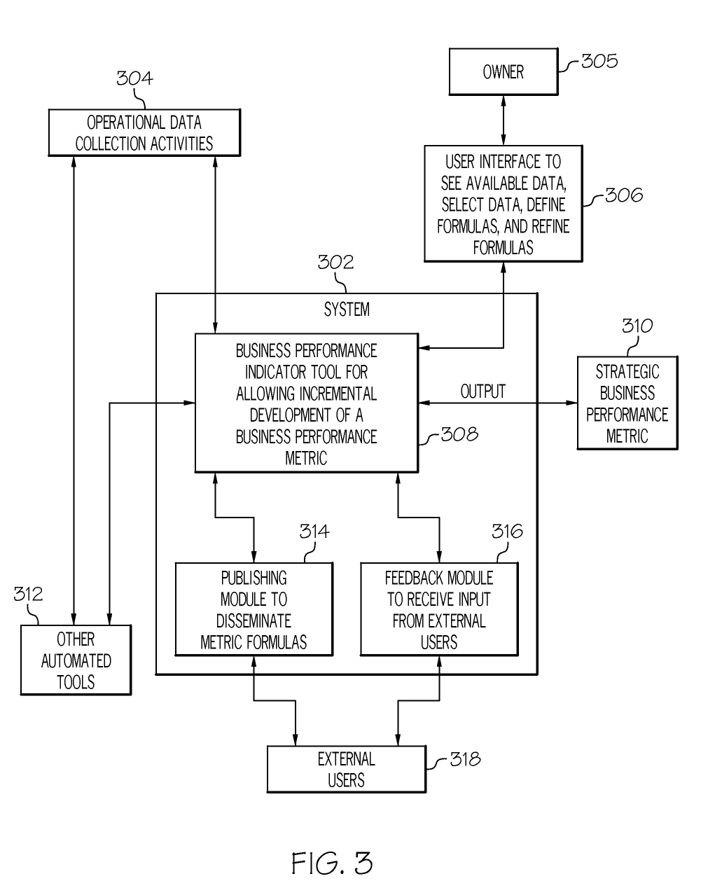

FIG. 3 illustrates a system 302 that may implement the process of FIGS. 1 and 2 in accordance with the principles of the present disclosure. The system 302 can include a software-based tool 308 that allows a user, or owner, to develop a new business performance indicator in a collaborative and incremental manner in accordance with the principles of the present disclosure. Independent of the operation of the tool 308, data collection activities 304 of a physical environment of an organization are occurring. Based on these activities 304, operational metrics of the organization are being measured and made available to a user of the tool 308.

The tool 308 can be utilized in different ways by different users. In particular, there may be external users 318 that have limited access to the various capabilities of the tool 308 and there may be an owner 305 that has full access to the capabilities of the tool 308.

As noted above, the owner 305 is an individual or team of individuals that has a responsibility within the organization to develop a new business performance indicator. The external users 318 have a role in the organization that may use the new business performance indicator or may have information or insight relevant to the development of the new business performance indicator.

The tool 308 provides a user interface 306 to the owner 305 that allows the owner to utilize the full capabilities of the tool 308. For example, the user interface 306 allows the owner to identify the data available because of the collection activities 304. Furthermore, the owner can use the interface 306 to select from the available data and construct an initial metric formula using that available data.

Once an initial metric formula is defined, then the system 302 can disseminate the formula to the external users 318. In particular, a publishing module 314 can be used that actively pushes the metric formula to the external users 318 (e.g., via e-mail) or more passively places the metric formula in a central repository where the external users 318 can access the metric formula if desired. The system 302 can include a feedback module 316 that receives input from the external users 318 once they have had an opportunity to review the published metric formula. The feedback from the external users 318 can include, for example, comments on how to refine or improve the metric formula. The feedback could also include suggestions for new metric formulas or related metric formulas that can be developed as well.

Via the feedback module 316 and the user interface 306, the owner of the new business performance metric can be provided with the input from the external users 318 and be permitted to refine the metric formula if desired. Thus, while both external users 318 and owner 305 can analyze and evaluate a metric formula, only the owner, using the user interface 306, is allowed to modify or refine the metric formula. In addition to external users 318, there may be automated tools 312 that can provide useful information for refining metric formulas. These automated tools 312 may have access to historical data and data from the collection activities 304. Using statistical analysis or artificial intelligence, the automated tools 312 may identify data that appears relevant to the new business performance indicator being developed. The tool 308 can then provide this additional information to the owner 305 via the user interface 306.

Once the owner 305 has defined a metric formula, received feedback, refined the formula, and interactively repeated that process, a formula for a new business performance indicator is derived. Accordingly, the tool 308 can then calculate and output a strategic business performance metric 310 that relates to this new business performance indicator. In the above-described iterative process, the interim metrics M₁, M₂, and M₃ correspond to a formula, at different stages of refinement, for how to calculate a value for this new business performance indicator. Thus, it is also contemplated that at each stage of refinement the strategic performance metric 310 can be calculated and output to the organization based on the interim metric formula for that particular stage of refinement.

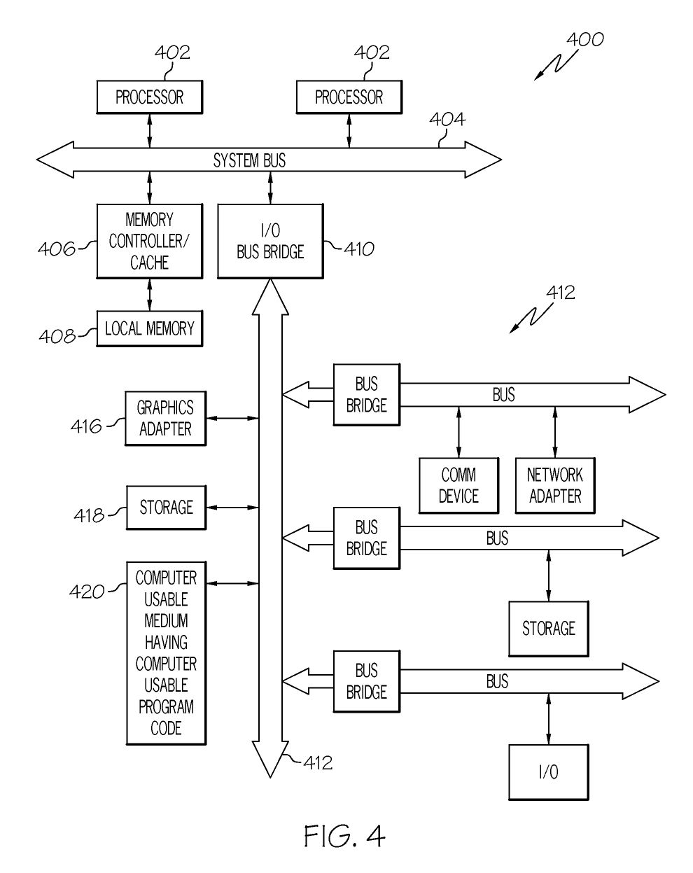

Referring to FIG. 4, a block diagram of a data processing system is depicted in accordance with the present disclosure. A data processing system 400, such as may be utilized to implement the hardware platform 108 or aspects thereof, e.g., as set out in greater detail in FIG. 1-FIG. 3, may comprise a symmetric multiprocessor (SMP) system or other configuration including a plurality of processors 402 connected to system bus 404. Alternatively, a single processor 402 may be employed. Also connected to system bus 404 is memory controller/cache 406, which provides an interface to local memory 408. An I/O bridge 410 is connected to the system bus 404 and provides an interface to an I/O bus 412. The I/O bus may be utilized to support one or more busses and corresponding devices 414, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 416, storage 418 and a computer usable storage medium 420 having computer usable program code embodied thereon. The computer usable program code may be executed to execute any aspect of the present disclosure, for example, to implement aspect of any of the methods, computer program products and/or system components illustrated in FIG. 1-FIG. 3.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method for developing a business performance indicator for an organization comprising:
presenting a plurality of measured operational values of the organization to a first member of the organization;
receiving from the first member a selection of a first operational value from amongst the plurality of measured operational values;
receiving, by a computer, from the first member of the organization a first metric formula M₁ related to the first operational value of the organization;
receiving, by the computer, from other members of the organization feedback information related to the first metric formula M₁;
receiving, by the computer, from the first member of the organization a refined metric formula based on the first metric formula M₁ and the feedback information; and
outputting, by the computer, the business performance indicator calculated by the computer according to the refined metric formula.

2. (canceled)

3. The method of claim 1, further comprising:
disseminating the first metric formula M₁ to the other members of the organization to generate the feedback information.

4. The method of claim 1, further comprising:
receiving from the first member a second metric formula M₂ based on the feedback information related to the first metric formula M₁ received from the other members of the organization; and
disseminating the second metric formula M₂ to the other members of the organization.

5. The method of claim 4, further comprising:
receiving from the first member identification of a business constant comprising a value; and
receiving from the first member a third metric formula M₃ whose value is based on the second metric formula M₂ and the business constant value.

6. The method of claim 5, further comprising:
receiving further feedback information from the other members of the organization regarding the third metric formula M₃.

7. The method of claim 5, further comprising:
receiving from the first member an identification of a measurable live operational value of the organization that is related to the business constant; and
defining the refined metric formula by replacing the business constant value in the third metric formula M₃ with the measurable live operational value.

8. The method of claim 1, wherein the first operational value comprises a measured hardware or software performance metric.

9. A computer program product for developing a business performance indicator for an organization comprising:
a non-transitory computer readable storage medium having computer readable program code embodied therewith, the computer readable program code comprising:
computer readable program code configured to present a plurality of measured operational values of the organization to a first member of the organization;
computer readable program code configured to receive from the first member a selection of a first operational value from amongst the plurality of measured operational values;
computer readable program code configured to receive from the first member of the organization a first metric formula M₁ related to the first operational value of the organization;
computer readable program code configured to receive from other members of the organization feedback information related to the first metric formula M₁;
computer readable program code configured to receive from the first member of the organization a refined metric formula based on the first metric formula M₁ and the feedback information; and
computer readable program code configured to calculate the business performance indicator according to the refined metric formula and output the calculated business performance indicator.

10. (canceled)

11. The computer program product of claim 9, further comprising:
computer readable program code configured to disseminate the first metric formula M₁ to the other members of the organization to generate the feedback information.

12. The computer program product of claim 9, further comprising:
computer readable program code configured to receive from the first member a second metric formula M₂ based on the feedback information related to the first metric formula M₁ received from the other members of the organization; and
computer readable program code configured to disseminate the second metric formula M₂ to the other members of the organization.

13. The computer program product of claim 12, further comprising:
computer readable program code configured to receive from the first member identification of a business constant comprising a value; and
computer readable program code configured to receive from the first member a third metric formula M₃ whose value is based on the second metric formula M₂ and the business constant value.

14. The computer program product of claim 13, further comprising:
computer readable program code configured to receive further feedback information from the other members of the organization regarding the third metric formula M₃.

15. The computer program product of claim 13, further comprising:
computer readable program code configured to receive from the first member an identification of a measurable live operational value of the organization that is related to the business constant; and
computer readable program code configured to define the refined metric formula by replacing the business constant value in the third metric formula M₃ with the measurable live operational value.

16. The computer program product of claim 9, wherein the first operational value comprises a measured hardware or software performance metric.

17. A system for developing a business performance indicator for an organization comprising:
a computer processor configured to execute instructions stored in a memory;
a first interface module configured to receive from a first member of the organization a first metric formula M₁ related to a first operational value of the organization, wherein the first interface module is further configured to:
present a plurality of measured operational values of the organization to the first member; and
receive from the first member a selection of the first operational value from amongst the plurality of measured operational values;
a second interface module configured to receive from other members of the organization feedback information related to the first metric formula M₁;
the first interface module configured to receive from the first member of the organization a refined metric formula based on the first metric formula M₁ and the feedback information;
a calculator module configured to calculate the business performance indicator according to the refined metric formula; and
a communication module configured to output the calculated business performance indicator.

18. (canceled)

19. The system of claim 17, further comprising:
the second interface module configured to disseminate the first metric formula M₁ to the other members of the organization to generate the feedback information.

20. The system of claim 17, further comprising:
the first interface module configured to receive from the first member a second metric formula M₂ based on the feedback information related to the first metric formula M₁ received from the other members of the organization; and
the second interface module configured to disseminate the second metric formula M₂ to the other members of the organization.

21. The system of claim 20, further comprising:
the first interface module configured to receive from the first member a third metric formula M₃ whose value is based on the second metric formula M₂ and the business constant value.

22. The system of claim 21, further comprising:
the second interface module configured to receive further feedback information from the other members of the organization regarding the third metric formula M₃.

23. The system of claim 21, further comprising:
the first interface module configured to receive from the first member an identification of a measurable live operational value of the organization that is related to the business constant; and
the calculator module configured to define the refined metric formula by replacing the business constant value in the third metric formula M₃ with the measurable live operational value.

24. The system of claim 17, wherein the first operational value comprises a measured hardware or software performance metric.
